(19) United States
(12) Patent Application Publication
(10) Pub. No.: US 2007/0149112 A1
(43) Pub. Date: Jun. 28, 2007

(54) Receiver device, network device, system, and method for AM (amplitude modulation) and/or FM (frequency modulation) reception

(76) Inventor: Jacques Latour, Gatineau (CA)

Correspondence Address: Jacques Latour, 11 Rue de Colbert, Gatineau, QC, J8T 8B4, CA

(21) Appl. No.: 11/318,020

(22) Filed: Dec. 27, 2005

(51) Int. Cl. H04H 7/00

(52) U.S. Cl. 455/3.06

(57) ABSTRACT

A receiver device has a receiver having one or more tuners for demodulating one or more AM (Amplitude Modulation) and/or FM (Frequency Modulation) radio frequency broadcast audio signals. One or more signal processing devices convert demodulated signals into respective data streams each having a respective streamed media audio format. Each data stream is transmitted to a respective destination address. A graphical user interface provides remote users with information on radio broadcasters that are available for listening. This allows a remote user to select a particular radio broadcaster for listening. The device can be connected to a network, and users, which may be in locations where AM/FM reception is weak, can nonetheless have access to radio broadcasts. In some implementations, the receiver device is implemented in a router, a PC (Personal Computer), a server, or in any suitable audio and/or video equipment.

### FIELD OF THE INVENTION

The invention relates to a receiver device, network device, system, and Method for reception AM and/or FM broadcasts.

### BACKGROUND OF THE INVENTION

Radio broadcasters, including commercial and community radio broadcasters, transmit AM/FM radio frequency broadcast audio signals that can be received by conventional AM/FM receivers. However, signal interference can occur due to the presence of concrete structures and electronic devices for example. As such, the strength of the AM/FM radio frequency broadcast audio signals may be insufficient for proper reception of the signals using conventional AM/FM receivers that operate in locations such as office complexes or other buildings. As a consequence radio broadcasters have difficulty in reaching listeners within such office complexes or buildings.

Most PCs (Personal Computers) used at home and businesses are equipped with audio processing software (media players), such as Nullsoft WINAMP®, Microsoft's Windows Media Player®, RealPlayer's RealAudio®, and Apple Computer's QuickTime® software. Such processing software allows a user to listen to music through their PCs. Many AM/FM radio broadcasting stations have enabled their radio broadcasts over the Internet in streamed media audio formats, and users can access the radio broadcasts through the Internet. However, in an office environment where there is a large number of employees for example the use of streamed audio media through the Internet for accessing radio broadcasts requires a large amount of resources within an IT (Information Technology) infrastructure and adds security risks to the end users. Furthermore, some employers question the programming content of certain radio broadcasters and its suitability in a work environment. Consequently, many employers impose restrictions making listening to the radio over the Internet unavailable to end users. This inability to listen to radio broadcasts results in a restriction on the number of listeners, which in turn limits the fees radio broadcasters can charge for advertisements.

### SUMMARY OF THE INVENTION

A receiver device is capable of receiving any one or more of AM (Amplitude Modulation) and/or FM (Frequency Modulation) radio frequency broadcast audio signals and capable of converting the signals into data streams each having a respective streamed media audio format. The receiver transmits the data streams to destination addresses. In some implementations the receiver device is connected to a network in an office building for example where reception of radio frequency broadcast audio signals cannot be achieved with conventional receivers. The receiver device and/or an RF (Radio Frequency) antenna coupled to the receiver device is positioned at a location where the radio frequency broadcast audio signals can be received.

Users at network devices on the network access programming from radio broadcasters by receiving from the receiver device over the network data streams containing audio data associated with the requested programming. This allows users to have access to radio broadcast programming at locations where reception of radio frequency broadcast audio signals cannot be achieved with conventional receivers. Furthermore, in contrast with conventional systems where users access radio broadcast programming through the Internet the above mechanism provides user access to radio broadcast programming through the network without causing a dramatic impact on network resources. In addition, in some implementations the receiver device has a tunable receiver allowing an employer to restrict employee access to certain radio broadcasters by tuning the receiver to one or more specific frequencies of reception. The low requirements on network resources and the capability of restricting access to radio broadcasts provides an incentive for employers to allow employees to listen to radio broadcast programming at work. Consequently, this allows radio broadcasters to reach a larger audience especially during work hours. Furthermore, in some implementations the receiver device has a monitoring unit for monitoring user statistics. The user statistics include a number of users and listening times for example. Such statistics are useful to radio broadcasters in determining the success of a particular programming and in obtaining income from advertisers.

In accordance with a first broad aspect, the invention provides a receiver device. The receiver device has a receiver having one or more tuners each adapted to demodulate a respective radio frequency broadcast audio signal to produce a demodulated signal. Each radio frequency broadcast audio signal is one of an AM radio frequency broadcast audio signal and an FM radio frequency broadcast audio signal. The receiver device has at least one signal processing device for converting each demodulated signal into a respective data stream having a streamed media audio format. The receiver device also has an interface for transmitting each data stream to a respective destination address.

In some embodiments of the invention, the interface has an interface function for receiving instructions to transmit a particular data stream to the respective destination address of the particular data stream.

In some embodiments of the invention, the interface function has a graphical user interface for providing to each destination address information on radio broadcasters that are available for listening.

In some embodiments of the invention, the graphical user interface is adapted to provide to each destination address information for selection of available streamed media audio formats.

In some embodiments of the invention, the graphical user interface is a graphical user web interface.

In some embodiments of the invention, the interface has an interface function for tuning the frequency of reception of each tuner.

In some embodiments of the invention, the interface function has a graphical user interface adapted to provide display information for selecting at a remote network device the frequency of reception of any of the one or more tuners.

In some embodiments of the invention, the graphical user interface is a graphical user web interface.

In some embodiments of the invention, the receiver has a plurality of tuners.

In some embodiments of the invention, the receiver has a plurality of signal processing devices.

In some embodiments of the invention, the interface has an interface function adapted to: responsive to receiving a request for programming of a particular radio broadcaster to be transmitted to a particular destination address, determine which data stream contains information on the programming of the particular radio broadcaster and transmit the data stream containing the information on the programming of the particular radio broadcaster to the particular destination address.

In some embodiments of the invention, each signal processing device comprises a DSP (Digital Signal Processor) for performing a media format conversion.

In some embodiments of the invention, each signal processing device comprises an ADC (Analog-to-Digital Converter).

In some embodiments of the invention, the receiver device has a monitoring function adapted to monitor user statistics for at least one radio broadcaster.

In some embodiments of the invention, the monitoring function is adapted to transmit the user statistics to a predetermined address.

In some embodiments of the invention, for each radio broadcaster the user statistics include information on the number of users and listening times.

In some embodiments of the invention, the receiver has only one tuner.

In some embodiments of the invention, a tuner is adapted to perform demodulation for only one frequency of reception.

In some embodiments of the invention, the radio frequency broadcast audio signal is a hybrid radio frequency broadcast audio signal containing digital information.

In some embodiments of the invention, a PC (Personal Computer) has the above receiver device.

In some embodiments of the invention, a computing device has the above receiver device.

In some embodiments of the invention, the receiver device has a DAC (Digital-to-Analog Converter) adapted to convert the respective data stream from a particular signal processing device into an analog signal, and an amplifier for amplifying the analog signal.

In some embodiments of the invention, the receiver device has at least one media player other than the receiver.

In some embodiments of the invention, the receiver device has means for performing digital processing functions on at least one digital signal from at least one media player other than the receiver to produce one or more respective data streams each having a streamed media format. The interface has an interface function for transmitting the one or more respective data streams to at least one destination address.

In some embodiments of the invention, a router has the above receiver device and a routing function for routing incoming data.

In some embodiments of the invention, the router has a firewall function for filtering the incoming data.

In accordance with a second broad aspect, the invention provides a network device having an interface adapted to receive from a receiver device information on user statistics for one or more radio broadcasters. The network device also has a processing function adapted to process the information to generate statistical information for use by the one or more radio broadcasters.

In accordance with a third broad aspect, the invention provides a system having one or more network devices coupled to a network and has a receiver device. The receiver device has a receiver with at least one tuner each adapted to demodulate a respective radio frequency broadcast audio signal to produce a demodulated signal. Each radio frequency broadcast audio signal is one of an AM radio frequency broadcast audio signal and an FM radio frequency broadcast audio signal. The receiver has at least one signal processing device for converting each demodulated signal into a respective data stream having a streamed media audio format. The receiver also has an interface for transmitting the respective data stream of each signal processing device to the one or more network devices.

In accordance with a fourth broad aspect, the invention provides a method that involves demodulating a radio frequency broadcast audio signal to produce a demodulated signal. The radio frequency broadcast audio signal is one of an AM radio frequency broadcast audio signal and an FM radio frequency broadcast audio signal. The method also involves converting the demodulated signal into a data stream having a streamed media audio format, and transmitting the data stream to a destination address.

In accordance with a fifth broad aspect, the invention provides a method for a program to interact with a user. The method involves transmitting information for displaying at least one element each representing a respective radio broadcaster that is available for listening. The method also involves receiving a selection of one of the at least one element, and transmitting a data stream obtained from a received radio frequency broadcast audio signal, the data stream having a streamed media audio format.

### BRIEF DESCRIPTION OF THE DRAWINGS

Preferred embodiments of the invention will now be described with reference to the attached drawings in which:

FIG. 1 is a system for distributing programming from radio broadcasters to listeners, in accordance with an embodiment of the invention;

FIG. 2A is a perspective view of a receiver device of FIG. 1;

FIG. 2B is a perspective view of another receiver device, in accordance with another embodiment of the invention;

FIG. 3A is a functional block diagram of the receiver device of FIG. 2A;

FIG. 3B is a functional block diagram of another receiver device, in accordance with another embodiment of the invention;

FIG. 4A is an example graphical display obtained from information provided by the receiver device of FIG. 3B;

FIG. 4B is an example graphical display obtained by selecting a display element of the graphical display of FIG. 4A, the graphical display of FIG. 4B providing display information for administrator access to administrative functions;

FIG. 4C is an example graphical display obtained after successful login by an administrator using the graphical display of FIG. 4B, the graphical display of FIG. 4C displaying display elements for performing administrative functions;

FIG. 4D is an example graphical display of the graphical display of FIG. 4C after a focus has been placed on a display element of the graphical display of FIG. 4C;

FIG. 5A is a block diagram of another receiver device, in accordance with another embodiment of the invention;

FIG. 5B is a block diagram of another receiver device, in accordance with another embodiment of the invention;

FIG. 5C is a block diagram of another receiver device, in accordance with another embodiment of the invention;

FIG. 6A is a block diagram of a tuner of the receiver device of FIG. 5A demodulating a radio frequency broadcast audio signal;

FIG. 6B is a block diagram of an ADC (Analog-to-Digital Converter) of the receiver device of FIG. 5A converting a demodulated signal into a digital signal;

FIG. 6C is a block diagram of a DSP (Digital Signal Processor) of the receiver device of FIG. 5A converting a digital signal into a data stream having a streamed media audio format;

FIG. 7 is a list of software used by a processor of the receiver device of FIG. 5A in an example implementation;

FIG. 8 is a block diagram of a network device coupled to the system of FIG. 1 and used for collecting user statistics;

FIG. 9 is a flow chart of a method employed by a receiver device in providing radio broadcast programming, in accordance with another embodiments of the invention;

FIG. 10A is a functional block diagram of a router, in accordance with another embodiment of the invention, and;

FIG. 10B is a functional block diagram of a receiver device, in accordance with another embodiment of the invention.

### DETAILED DESCRIPTION OF THE PREFERRED EMBODIMENTS

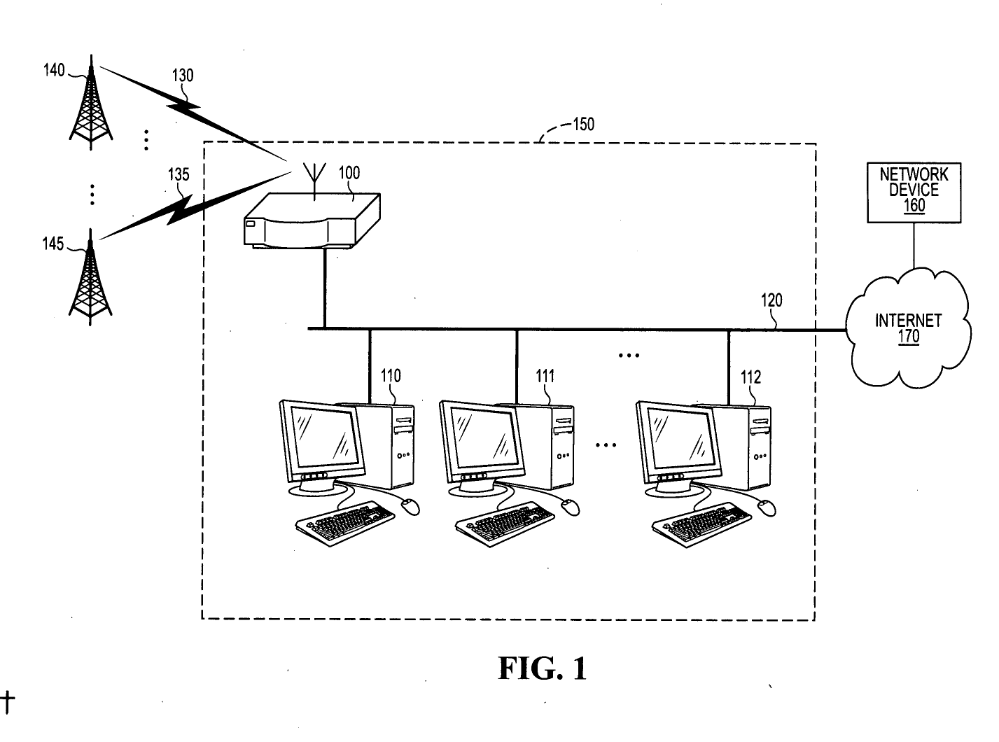

Radio broadcasters transmit AM/FM (Amplitude modulation/Frequency Modulation) radio frequency broadcast audio signals that can be received by any conventional AM/FM receiver. In some instances, such as in some buildings and office complexes for example, the strength of the AM/FM radio frequency broadcast audio signals may be insufficient for proper reception of the signals. An efficient system for allowing listeners to access radio broadcast programming in an environment where reception of broadcast signals is limited will now be described below with reference to FIG. 1. However, it is to be clearly understood that embodiments of the inventions are not limited to environments where reception is limited.

Referring to FIG. 1, shown is a system generally indicated by 150 for distributing programming from radio broadcasters to listeners, in accordance with an embodiment of the invention. The system 150 has a receiver device 100 and network devices 110, 111, 112 coupled to a network 120. The network 120 is any suitable network, such as a LAN (Local Area Network) or WAN (Wide Area Network) for example, capable of providing a communications means between the receiver device 100 and the network devices 110, 111, 112. Only three network devices 110, 111, 112 are shown for purposes of clarity. More generally, one or more network devices are on the network 120. The receiver device 100 receives radio frequency broadcast audio signals 130, 135 from radio broadcasting stations 140, 145. The receiver device 100 is in communication with a network device 160 through the network 120 and Internet 170. In FIG. 1 the receiver device 100 is shown receiving radio frequency broadcast audio signals from only two radio broadcasting stations for purposes of clarity. In some embodiments of the invention, the receiver device 100 is capable of receiving radio frequency broadcast audio signals from one or more radio broadcasting stations. Each of the radio frequency broadcast audio signals 130, 135 is an AM radio frequency broadcast audio signal or an FM radio frequency broadcast audio signal. The receiver device 100 is tuned to demodulate the radio frequency broadcast audio signals 130, 135 and convert them into respective data streams each having a respective streamed media audio format.

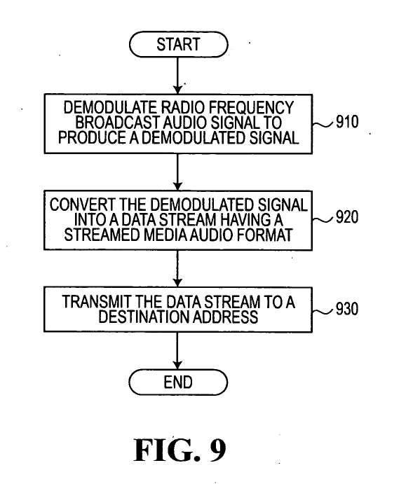

A method for a receiver device, such as the receiver device 100 of FIG. 1 for example, to provide broadcast programming will now be described with reference to FIG. 9. In FIG. 9, at step 910 the receiver device demodulates a radio frequency broadcast audio signal to produce a demodulated signal. The radio frequency broadcast audio signal is an AM radio frequency broadcast audio signal or an FM radio frequency broadcast audio signal. At step 920 the receiver device converts the demodulated signal into a data stream having a streamed media audio format. At step 930 the receiver device transmits the data stream to a destination address.

Referring back to FIG. 1, in some embodiments of the invention the receiver device 100 is equipped with a plurality of tuners (not shown in FIG. 1) each capable of demodulating a respective radio frequency broadcast audio signal to allow listeners to listen to various radio broadcasts at any instant in time. For each of the network devices 110, 111, 112 that requests programming from a particular radio broadcaster the receiver device 100 transmits a data stream obtained from one of the radio frequency broadcast audio signals 130, 135 that is transmitted by the radio broadcasting station of the particular radio broadcaster. The network devices 110, 111, 112 are equipped with audio processing software (not shown) for converting received data streams into analog signals for listening. When more than one of the network devices 110, 111, 112 request programming from the same radio broadcaster the receiver device 100 transmits to the network devices making the request copies of the data stream obtained from a radio frequency broadcast signal transmitted by the radio broadcaster. This allows multiple users to listen to the same radio broadcaster. The receiver device 100 also monitors user statistics for one or more radio broadcasters, and transmits the user statistics to the network device 160. For each radio broadcaster the user statistics include for example information on the number of users and listening times.

In the embodiment of FIG. 1, there is only one receiver device 100. However, it is to be clearly understood that in some other embodiments of the invention there is one or more additional receiver devices coupled to the network 120, each capable of providing the functionality of the receiver device 100.

In FIG. 1, the network devices 110, 111, 112 are PCs (Personal Computers). However, it is to be clearly understood that the network devices are any suitable network devices capable of receiving data streams. Furthermore, the network devices 110, 111, 112 are shown being connected locally on the network 120. However, in some implementations one or more network devices are connected through the Internet 170 for example, and access radio broadcast programming transmitted by the receiver device 100.

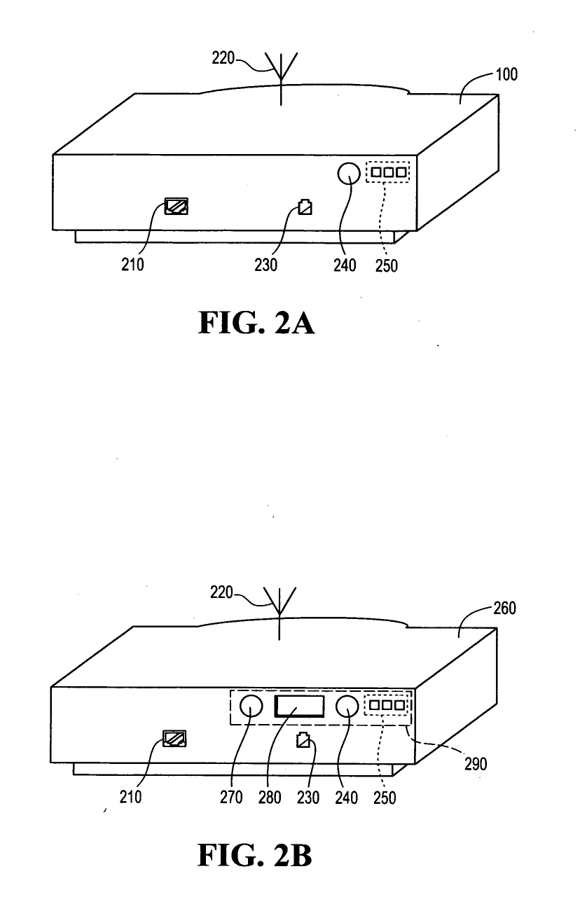

Referring to FIG. 2A, shown is a perspective view of the receiver device 100 of FIG. 1. The receiver device 100 has a network interface port 210, such as an Ethernet port for example, a radio frequency antenna 220, a radio frequency antenna port 230, a tuner selector 240 and a signal strength indicator LED (Light Emitting Diode) 250. The network interface port 210 is used for connection to the network 120 of FIG. 1. The radio frequency antenna 220 receives radio frequency broadcast audio signals, and the radio frequency antenna port 230 is used to connect an external radio frequency antenna (not shown). The receiver device 100 is capable of being used with only the radio frequency antenna 220, only an external radio frequency antenna, or both the radio frequency antenna 220 and an external radio frequency antenna. When used in a building only with the, radio frequency antenna 220 the receiver device 100 is preferably located where there is good reception, such as close to an exterior window for example.

The receiver device 100 of FIG. 2A has one radio frequency antenna 220 and one radio frequency antenna port 230. In some embodiments there is no radio frequency antenna 220 and in other embodiments there is no radio frequency antenna port 230. More generally, there are one or more radio frequency antennae and/or one or more radio frequency antenna ports. The tuner selector 240 and the signal strength indicator LED 250 are used to collectively provide an indication of the strength of each radio frequency broadcast signal being received. Furthermore, in some embodiments of the invention the receiver device 100 is equipped with a reset button for resetting the receiver device 100.

As discussed in detail below, the receiver device 100 can be tuned remotely from any suitable remote network device. In some embodiments of the invention, a receiver device can be tuned remotely and/or tuned locally at the receiver device. Such a device is shown as receiver device 260 in FIG. 2B. The receiver device 260 is similar to the receiver device 100 of FIG. 2A except that the receiver device 260 has a user interface 290 for tuning the receiver device 260. The user interface 290 has a frequency selector 270, a frequency indicator 280, the tuner selector 240, and the signal strength indicator 250. In some embodiments of the invention, the user interface 290 is also equipped with a mode selector for selecting between AM and FM modes. In the embodiment of FIG. 2B the receiver 260 has a plurality of tuners (not shown) that can be tuned to receive more than one radio frequency broadcast signals at any instant in time. To tune the receiver device 260 the tuner selector 240 is used to select a particular tuner to tune. The frequency selector 270 is used to tune the selected tuner to the frequency of a radio frequency broadcast signal to receive.

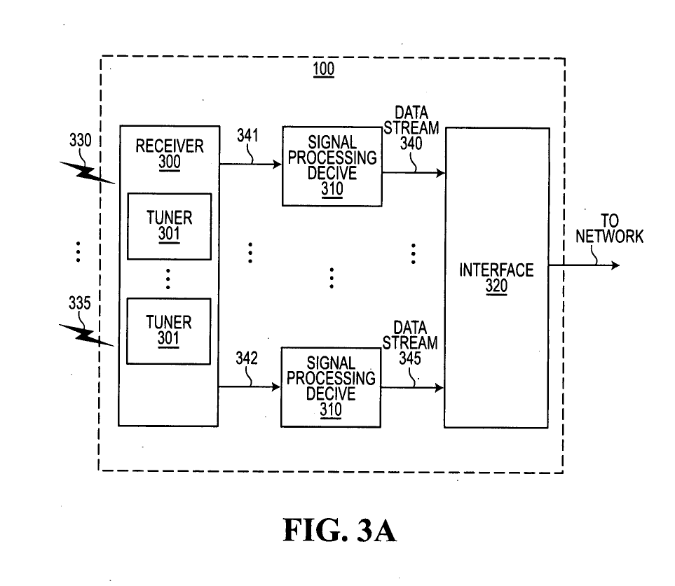

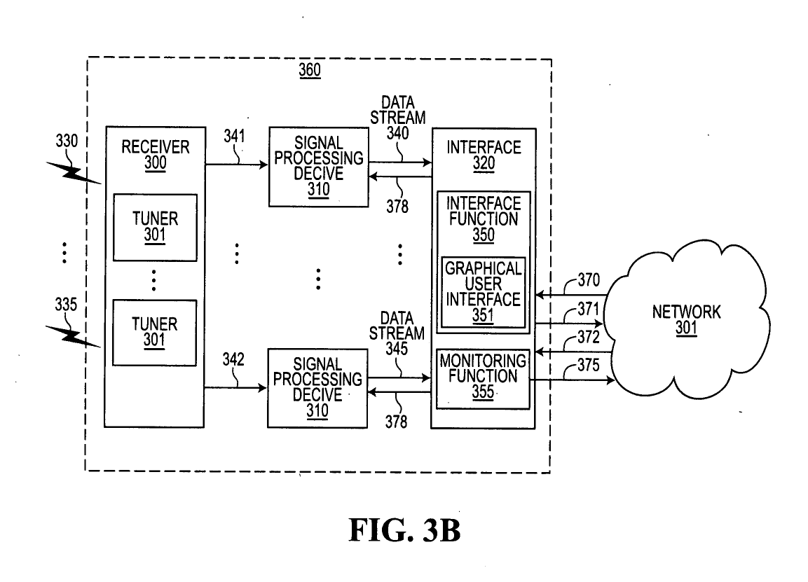

Referring to FIG. 3A, shown is a functional block diagram of the receiver device 100 of FIG. 2A. It is to be clearly understood, however, that the functional block diagram of FIG. 3A is also applicable to the receiver device 260 of FIG. 2B. The receiver device 100 has a receiver 300, signal processing devices 310, and an interface 320. The receiver 300 has tuners 301 adapted to demodulate radio frequency broadcast audio signals 330, 335 to produce demodulated signals 341, 342. Only two radio frequency broadcast audio signals 330, 335 are shown for purposes of clarity. However, it is to be clearly understood that the invention is not limited to reception of two radio frequency broadcast audio signals. More generally, a receiver device is capable of demodulating one or more radio frequency broadcast audio signals at any instant in time. In the embodiment of FIG. 3A the receiver device 100 is tunable to demodulate any of the radio frequency broadcast audio signals 330, 335. As discussed above with reference to FIG. 1, each of the radio frequency broadcast audio signals 330, 335 is an AM radio frequency broadcast audio signal or an FM radio frequency broadcast audio signal. The signal processing devices 310 convert the demodulated signals 341, 342 from the receiver 300 into respective data streams 340, 345 each having a respective streamed media audio format. The interface 320 transmits the data streams.

In FIG. 3A only two signal processing devices 310 are shown for purposes of clarity. However, it is to be clearly understood that in some embodiments of the invention there are more than two signal processing devices 310. More generally, there are one or more signal processing devices 310. Similarly, only two tuners 301 are shown for purposes of clarity. However, it is to be clearly understood that in some embodiments of the invention there are more than two tuners 301. More generally, there are one or more tuners 301. Furthermore, in the embodiment of FIG. 3A the number of tuners 301 equals the number of signal processing devices 310. However, embodiments of the invention are not limited to a one-to-one correspondence between the number of tuners 301 and the number of signal processing devices 310. In some embodiments of the invention there are more signal processing devices 310 than tuners 301 while in some other embodiments of the invention there are fewer signal processing devices 310 than tuners 301.

Referring to FIG. 3B, shown is a functional block diagram of another receiver device 360, in accordance with another embodiment of the invention. The receiver device 360 of FIG. 3B is similar to the receiver device 100 of FIG. 3A except that the receiver device 360 has an interface function 350 and a monitoring function 355. In addition, the interface function 350 has a graphical user interface 351.

The monitoring function 355 monitors user statistics for one or more radio broadcasters. The monitoring function 355 is also used in transmitting user statistics 375 to a predetermined address.

The interface function 350 is used for receiving instructions 370 to transmit the data streams 340, 345 to destination addresses. The instructions 370 include for example a request for programming of a particular radio broadcaster to be sent to a destination address, the request originating from a remote network device (not shown). In some implementations the instructions 370 specify for example the destination address and a radio broadcaster and/or frequency of a frequency broadcast audio signal. Responsive to receiving the instructions 370 the interface function 350 determines which of the data streams 340, 345 is required to be transmitted to the destination address based on the instructions 370, and instructs the interface 320 to transmit the required data stream to the destination address by way of a network 301.

The destination address is an IP (Internet Protocol) address or any other suitable address for sending the required data stream to the destination address. In the embodiment of FIG. 3B, the receiver device 360 receives instructions to transmit data streams to specific destination addresses. In some of these implementations the data streams are transmitted as unicast messages for example using unicast destination addresses. However, as can be seen from the embodiment of FIG. 3A, in some implementations a receiver device does not receive instructions to transmit data streams to specific destination addresses. In some of these implementations the data streams are transmitted as multicast messages for example using multicast destination addresses.

In some embodiments of the invention the interface function 350 also receives instructions 372 specifying the type of streamed media audio format a particular data stream is to be sent to the destination address. Responsive to receiving the instructions 372 the interface 350 provides to any of the signal processing devices 310 that is processing the particular data stream instructions 378 for converting signals into the specified type of streamed media audio format. Examples of types of streamed media audio formats include for example but are not limited to MP3 audio streams, Windows Media Player streams, and Real Player streams.

In the embodiment of FIG. 3B the graphical user interface 351 provides information 371 on radio broadcasters that are available for listening. In some implementations the graphical user interface 351 is a web interface, and a remote user accesses the receiver device 360 through the web interface 351. However, it is to be clearly understood that implementations are not limited to the use of a web interface and that in other implementations other types of interfaces are used, such as client based requests and/or XML (eXtensible Markup Language) requests for example.

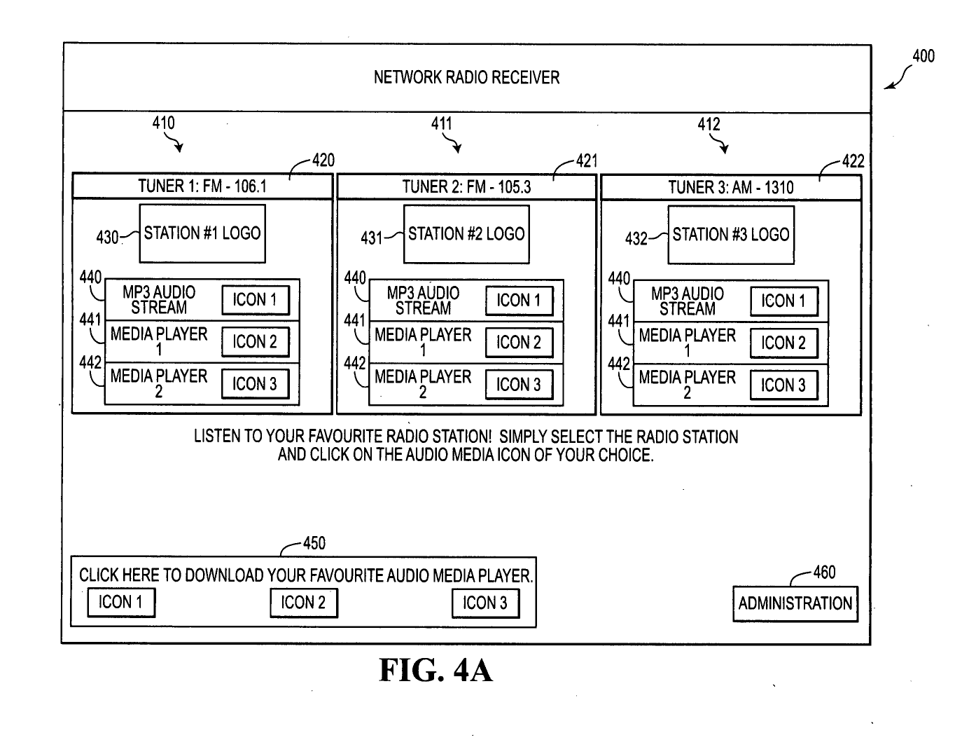

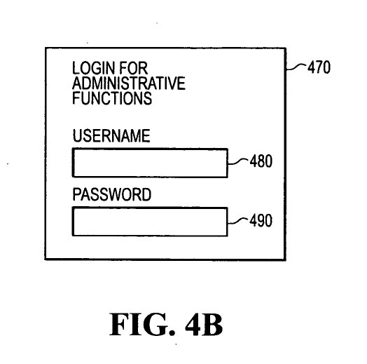

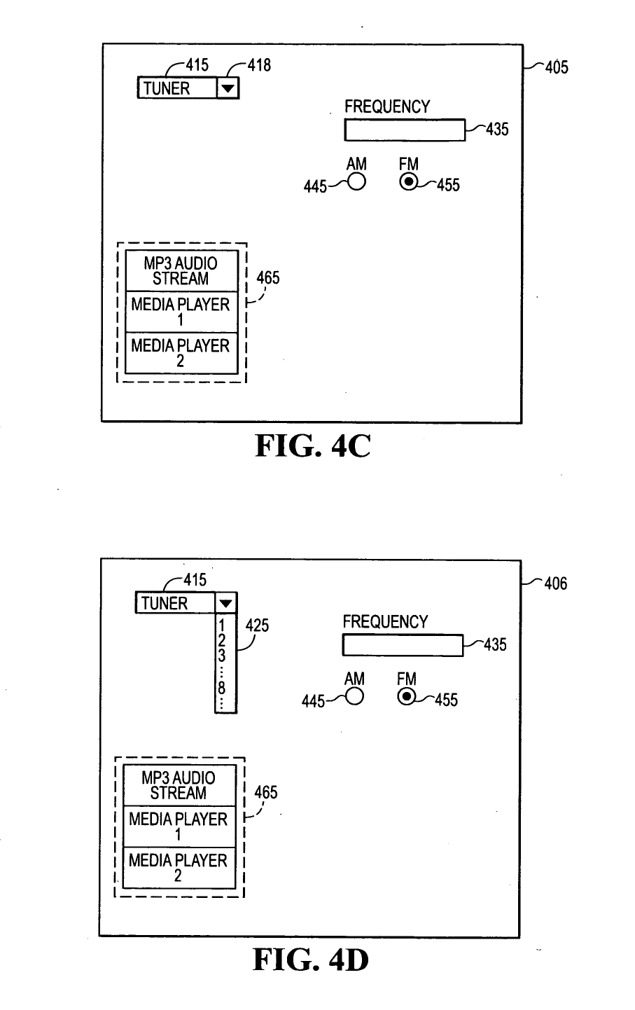

The information 371 is transmitted to a destination address by way of the network 301 for selection of a particular radio broadcaster. In the embodiment of FIG. 3B the information 371 contains graphical display information. In some implementations the graphical display information is displayed for user selection. FIG. 4A shows an example graphical display 400 obtained from the information 371 provided by the receiver device 360 of FIG. 3B, the graphical display being displayed remotely for use by a user in selecting various options for listening to radio broadcasts. The graphical display 400 has three display elements 410, 411, 412. The display elements 410, 411, 412 contain respective display elements 420, 421, 422, which identify by frequency of reception and mode (FM or AM) radio broadcasters that are available for listening. The display elements 410, 411, 412 contain respective display elements 430, 431, 432, which identify using a logo for example radio broadcasters that are available for listening. Each display element 410, 411, 412 also contains respective display elements 440, 441, 442, which identify by name and iconic representation available streamed media audio formats. In an example implementation a user selects a radio broadcaster by selecting one of the display elements 410, 411, 412, 420, 421, 422. Furthermore, the graphical display 400 serves as an interface for setting up a media session with the receiver device 360. For example, in an example implementation the selection of a particular display element 410, 411, 412, 420, 421, 422 results in a request for a media session to be transmitted to the receiver device 360. A user also selects a type of streamed media audio format by selecting one of the display elements 440, 441, 442 in one of the display elements 410, 411, 412.

The graphical display 400 also has a display element 450 for displaying downloadable media players that are compatible with the available streamed media audio formats. The downloadable media players are identified using icon 1, icon 2, and icon 3 in display element 450. Each media player in the display element has an associated link to a respective remote site, and the user selects a particular media player for downloading, if necessary, so that a received data stream can be converted into an analog signal for listening.

The graphical display 400 also has an administration function display element 460. An administrator can implement administration functions such as tuning the frequency or frequencies of reception of a receiver device and setting the types of available streamed media audio formats by selecting the display element 460. In an example implementation, the selection of the display element 460 results in another graphical display being displayed. An example of such a graphical display is shown as graphical display 470 in FIG. 4B. The graphical display 470 has display elements 480, 490 for entering a user name and password, respectively. This allows access to administrative functions. Once correct user name and password are entered another graphical display is displayed. An example of such a display is shown as graphical display 405 in FIG. 4C. The graphical display 405 has display elements 415, 418 for selecting tuners to be tuned. The graphical display 405 has a display element 435 that provides a window for a user input of a frequency of reception. The graphical display 405 has display elements 445, 455 that are used for selecting AM and FM modes, respectively. The graphical display 405 also has a display element 465 that identifies available streamed media audio formats.

To select a particular tuner to tune a user focuses on the graphical display 418. This results in another graphical display, shown as graphical display 406 in FIG. 4D, to be displayed. The graphical display 406 is similar to the graphical display 405 of FIG. 4C except that an additional display element 425 is displayed. The display element 425 has a list of tuner identifiers each identifying a respective tuner. A user selection of a particular tuner is made by selecting the identifier of the particular tuner in the display element 425.

A user selects a particular radio broadcaster by entering the frequency of transmission of the radio broadcaster in display element 435 and by selecting one of display elements 445, 455 to specify the mode of transmission used by the radio broadcaster. The user selects one or more formats for transmission of data streams by selecting the appropriate format or formats in the display element 465.

It is to be clearly understood that the graphical displays 400, 470, 405, and 406 of FIGS. 4A, 4B, 4C, and 4D are shown as examples only and that the invention is not limited to those example. For example, in some implementations a receiver device is capable of transmitting data streams using only one streamed media audio format. In some of these implementations the graphical display 400 of FIG. 4A does not have display elements 440, 441, 442, 450, and the graphical displays 405, 406 of FIGS. 4C and 4D do not have display element 465. Furthermore, as discussed above with reference to FIG. 2B, in some embodiments of the invention a receiver device has a user interface for tuning the receiver device locally. In some of these embodiments, the receiver device is only tunable locally and there is no interface function for remote tuning. In some of these embodiments the graphical display 400 of FIG. 4A does not have the display element 460. Furthermore, in the graphical display 400 of FIG. 4A there are only three display elements 410, 411, 412 being displayed. More generally, there are none or more such display elements being displayed. In particular, as discussed above in some implementations a receiver device has only one tuner, and the tuner is pre-configured for reception at a pre-determined frequency. In some of these implementations the frequency of reception cannot be changed and there is only one radio station that can be listened to by listeners. In some of these implementations there are no elements 410, 411, 412. Instead the display elements elements 410, 411, 412 are replaced with another display element for use in user selection for requesting broadcast programming for example.

It is to be clearly understood that the invention is not limited to the administration functions discussed above with reference to FIGS. 4A, 4B, 4C, and 4D. For example, in some implementations other functions include for example an administration function for configuring IP (Internet Protocol) address settings and an administration function for uploading new versions of software on a receiver device. Furthermore, in some implementations another administration function allows an administrator to upload onto the receiver device logos of radio broadcasters for display to users.

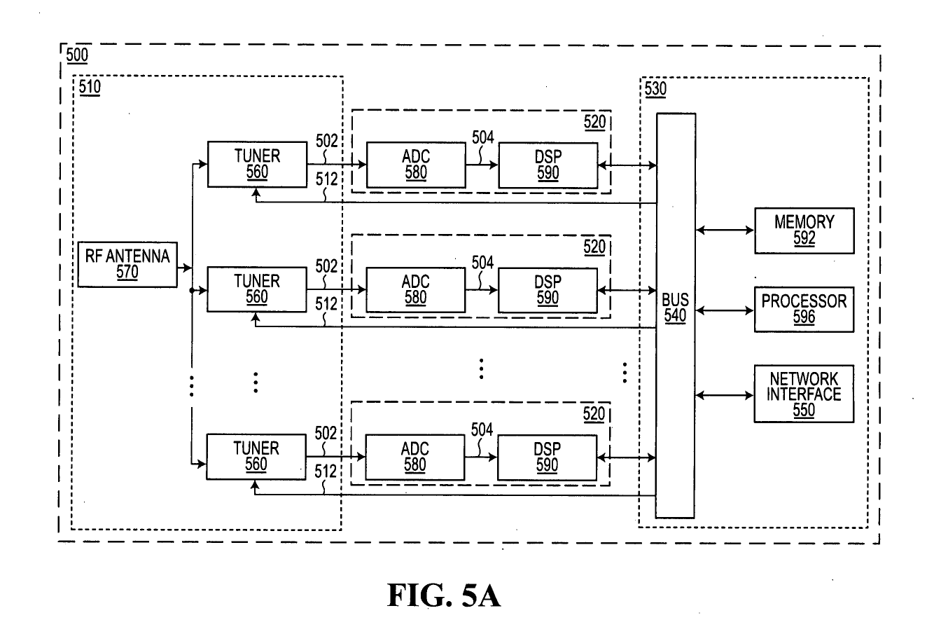

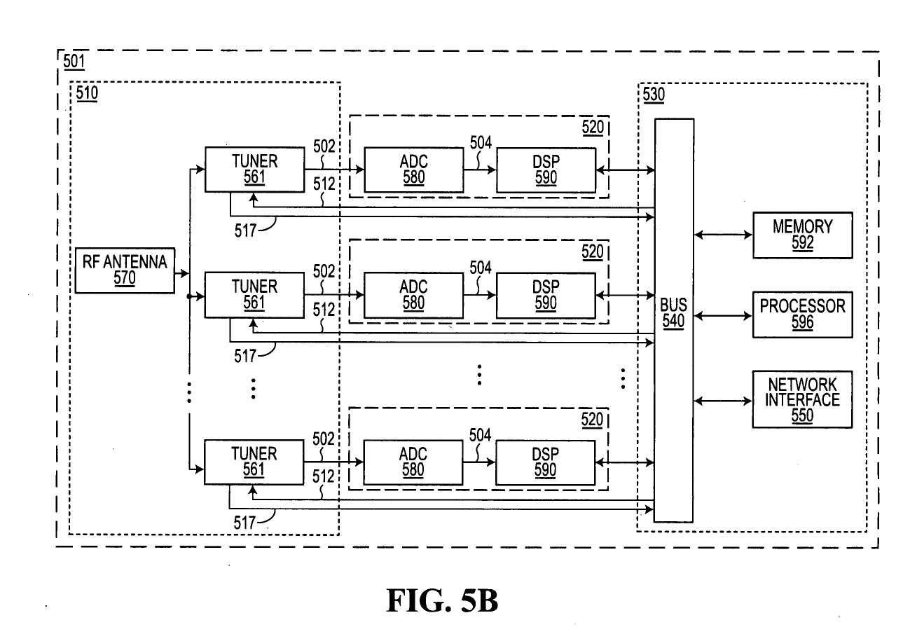

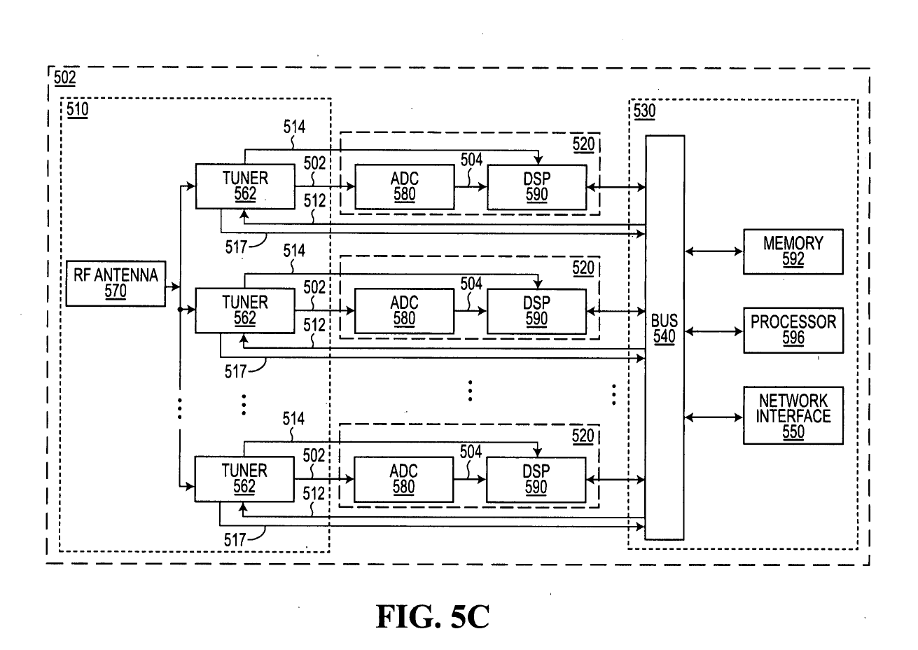

Referring back to the receiver device 100 of FIG. 3A, further details of the functionality of the receiver 300, the signal processing devices 310, and the interface 320 will now be discussed with reference to FIGS. 5A, 5B, and 5C. In FIG. 5A shown is a block diagram of another receiver device 500, in accordance with another embodiment of the invention. The receiver device 500 has a receiver 510 and signal processing devices 520 each coupled to the receiver 510. The receiver device 500 also has an interface 530 coupled to the signal processing devices 520. The receiver 510 has tuners 560 each coupled to an RF (Radio Frequency) antenna 570. The signal processing devices 520 have ADCs (Analog-to-Digital Converters) 580 and DSPs (Digital Signal Processors) 590. The interface 530 has a bus 540, a memory 592, a processor 596, and a network interface 550.

Each tuner 560 is an AM/FM tuner capable of demodulating AM and FM radio frequency broadcast signals received by the RF antenna 570. Each tuner 560 is tuned to demodulate an AM or FM radio frequency broadcast audio signal at a predetermined frequency to produce demodulated signals 502. The ADCs 580 convert the demodulated signals 502 received from the tuners 560 into digital signals 504. The DSPs 590 convert the digital signals 504 into data streams each having a respective streamed media audio format, and the interface 530 processes the data streams for transmission over a network.

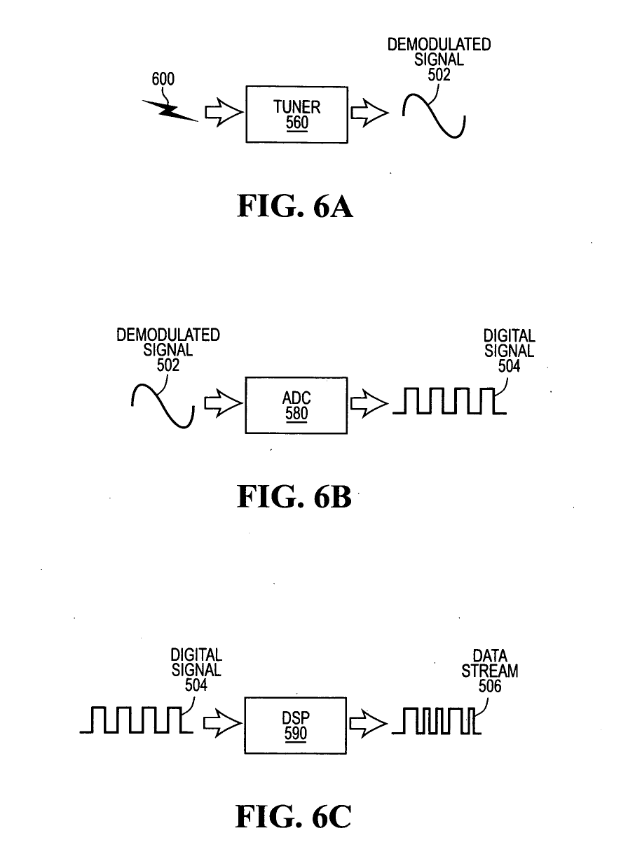

Further details of the functionality of the tuners 560, the ADCs 580, and the DSPs 590 will now be described with reference to FIGS. 6A, 6B, and 6C. In FIG. 6A a radio frequency broadcast audio signal 600 is demodulated by one of the tuners 560 to produce the demodulated signal 502. In FIG. 6B the ADC 580 receives the demodulated signal 502 and converts it into digital signal 504. In FIG. 6C the DSP 590 receives the digital signal 504 and converts it into data samples having a media audio format. The conversion is performed at a predetermined sampling rate and the DSP 590 stores the digital samples. The DSP 590 then sends the data samples as a data stream 506 having a streamed media audio format. It is to be clearly understood that the data stream is any suitable data stream containing a number of data samples transmitted over a period of time and having a streamed media audio format.

Referring back to FIG. 5A, the interface 530 receives instructions for tuning the frequency of reception of each tuner 560 and provides instructions to the tuners 560 by way of data paths 512. The instructions include for example a mode selection (AM or FM) and a frequency of reception. In the embodiment of FIG. 5A, the memory 592 contains software for a graphical user interface. The software is used by the processor 596 to implement the graphical user interface. When the interface 530 receives from a remote network device a request for tuning the tuners 560 in the form of a user name and password for example the interface 530 transmits to the remote network device display information for selecting the frequency of reception of each tuner 560. Responsive to receiving instructions for tuning the frequency of reception of the tuners 560 the interface 530 provides the tuning instructions to the tuners 560.

In some embodiments of the invention, one or more of the tuners 560 are untunable, each being configured for demodulation at only-one respective frequency of reception. For example, any one or more of the tuners 560 is rendered untunable by pre-setting the tuners during manufacturing. This is achieved for example by storing software in the memory 592 containing instructions for setting the frequency or frequencies of reception of any one or more of the tuners 560 and containing instructions for leaving the frequency or frequencies of reception unchanged. The processor 596 uses the instructions to configure the tuners 560 that are to be rendered untunable and leaves the frequency or frequencies of reception of these tuners unchanged.

The interface 530 also receives instructions from remote network devices, each instruction requesting programming from a respective radio broadcaster. Responsive to receiving instructions from a remote network device the processor 596 determines which of the data streams is to be transmitted based on the radio broadcaster requested. In an example implementation the processor 596 creates a session, assigns a session identification number, and stores the identification number in the memory 592 together with an identification of a frequency of reception and a mode for example. The interface 530 also receives instructions requesting a particular type of streamed media audio format for the data stream. Responsive to receiving the instructions the processor 596 stores in the memory 592 an identification of the streamed media audio format requested. The processor 596 then operates on the data stream for transmission to the remote network device. For example, in the example implementation the processor 596 creates copies of the digital samples stored at a particular one of the DSPs 590 and stores the copies in the memory 592 together with a sequence index for each sample. As will be discussed in further details below, in some implementations the processor 596 converts the digital samples stored in the memory 592 into the streamed media audio format requested. In the example implementation the processor 596 then creates a streaming audio media packet containing a destination address, digital samples, and a sequence index, and forwards the packet to the network interface 550. The network interface 550 then sends the packet as part of a data stream. For example, in some implementations the packet is encapsulated in HTTP (TCP) (HyperText Transfer Protocol) using TCP (Transfer Control Protocol) or encapsulated using a streaming protocol such as RTSP (Real Time Streaming Protocol) utilizing UDP (User Datagram Protocol).

As discussed above the interface 530 also receives from remote network devices instructions on the type of streamed media audio format data streams are to be received. In some instances two or more remote network devices may request programming from the same radio broadcaster. However, the requests may include instructions to receive the data streams in different streamed media audio formats. In the embodiment of FIG. 5A the DSPs 590 are multi-format encoders capable of encoding and compressing a digital audio signal to produce one or more data streams each having a respective streamed media audio format. For each request for programming received from remote network devices the processor 596 determines from which DSP 590 data streams need to be processed for transmission to the network device requesting the programming. If a request contains information on the type of streamed media audio format a data stream is to be sent the processor 596 instructs the appropriate DSP 590 to produce a data stream having the specified format. Responsive to receiving the instructions from the processor 596 the appropriate DSP 590 determines whether it is already producing a data stream having the specified format and, if not, produces an additional data stream having the specified format. In this way, at any instant in time each DSPs 590 can produce data streams of more than one streamed media audio format. However, DSPs having such capabilities can be expensive.

In other implementations one or more of the DSPs 590 are multi-format encoders each capable of providing more than one streamed media audio format but such DSPs only provide a single streamed media audio format at any instant in time. In some of these implementations the interface 530 is equipped with media conversion software, such as any one or more of MP3 streaming software, Real Audio streaming software, and Microsoft Streaming Media software for example, for converting the data streams between streamed media audio formats. When a request for a streamed media audio format is received from a remote network device the processor 596 determines whether the DSP 590 responsible for producing the data stream that is to be sent to the remote network device is outputting the data stream in the requested streamed media audio format. If the data stream has a different format the processor 596 makes a copy of the data stream, converts the copy to the requested streamed media audio format, and stores the copy in the memory 592 prior to transmission to the remote network device.

In yet other implementations one or more of the DSPs 590 are capable of providing a single streamed media audio format. When a request for a streamed media audio format is received from a remote network device the processor 596 determines whether the DSP 590 responsible for producing the data stream that is to be sent to the remote network device is outputting the data stream in the requested streamed media audio format. If the data stream has a different format the processor 596 makes a copy of the data stream, converts the copy to the requested streamed media audio format, and stores the copy in the memory 592 prior to transmission to the remote network device.

It is clear that there are different types of DSPs that can be used. Implementations in which the DSPs 590 are multi-format encoders each capable of providing more than one streamed media audio format at any instant in time do not require the processor 596 to perform any conversions between formats and have a high performance. On the other hand, receiver devices that make use of less sophisticated DSPs and have the processor 596 perform format conversions are less expensive.

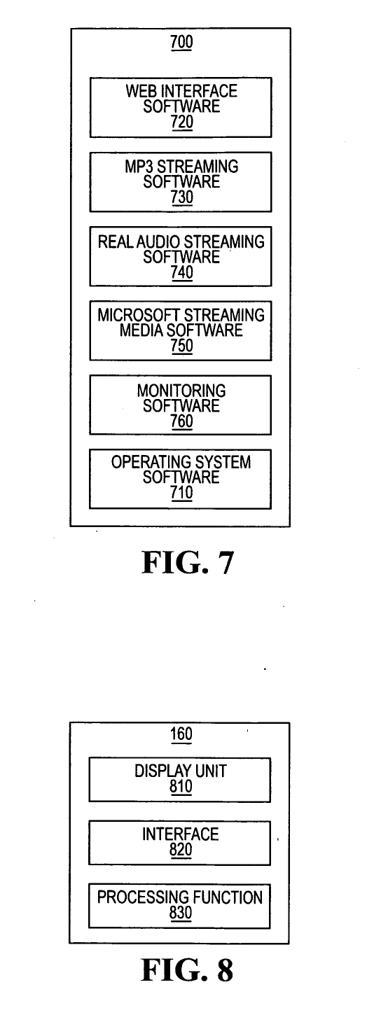

In the embodiment of FIG. 5A, the functionality of the interface 530 is implemented using the bus 540, the network interface 550, the processor 596, the memory 592, and software stored in the memory 592 for use by the processor 596. Some of the software used in an example implementation will now be described with reference to FIG. 7. In FIG. 7 shown is a list 700 of software used by the processor 596 of FIG. 5A in the example implementation. The list 700 includes web interface software 720, MP3 streaming software 730, Real Audio streaming software 740, Microsoft Streaming Media software 750, monitoring software 760, and operating system software 710.

The operating system software 710 is used to provide an operating system for the receiver device 500. The web interface software 720 is used to provide a graphical user interface for remote users. The monitoring software 760 is used to obtain user statistics. The MP3 streaming software 730, the Real Audio streaming software 740, and the Microsoft Streaming Media software 750 are used by the processor 596 for media format conversions. For example, the Real Audio streaming software 740 is used to decode an MP3 data stream and encode it into a Real Audio streaming format.

It is to be clearly understood that embodiments of the invention are not limited to the example software of FIG. 7, and that in other examples more or less software is used. For example, as discussed above, in some implementations each signal processing device 520 of the receiver device 500 of FIG. 5A is capable of outputting a data streams in more than one format at any instant in time, and there is no need for the processor 596 to perform any media format conversions. In some of these implementations there is no MP3 streaming software 730, no Real Audio streaming software 740, and no Microsoft Streaming Media software 750.

Referring back to FIG. 5A, the receiver 510, the signal processing devices 520, and the interface 530 of the receiver device 500 are implemented using hardware or a combination of hardware and software. It is to be clearly understood that functionally within the receiver device 500 can be implemented using any suitable hardware, software, firmware, and/or any suitable combination thereof.

In some embodiments of the invention, one or more of the tuners 560 are stereo tuners. In some embodiments of the invention one or more of the tuners 560 are equipped with a signal quality detection system that is used to determine signal strength and provide information on whether a frequency lock is established.

In some embodiments of the invention, one or more of the ADCs 580 are stereo audio codecs.

In some embodiments of the invention one or more of the DSPs 590 have software and/or firmware to perform digital sound processing functions such as media format encoding and decoding, de-emphasis, volume control, noise reduction, bass and treble control for example.

Some radio broadcasters transmit digital information in addition to analog audio information using the United States' RBDS (Radio Broadcast Data System) or Europe's RDS (Radio Data System) for example. This information includes for example but is not limited to information on the name of a radio broadcaster and the name of a song. In FIG. 5B shown is a block diagram of another receiver device 501, in accordance with another embodiment of the invention. The receiver device 501 is similar to the receiver device 500 of FIG. 5A except that the tuners 560 are replaced with tuners 561. The tuners 561 demodulate radio frequency broadcast audio signals to extract analog and digital information. The digital information is transmitted by way of data paths 517 to the processor 596 for processing, and the analog information is transmitted to the ADCs 580. In some implementations the information is made available to users by having the interface 530 transmit the information as metadata in the data stream or separate from the data stream.

Referring back to FIG. 1, the receiver device 100 receives radio frequency broadcast audio signals from radio broadcasting stations 140, 145. The radio broadcasting stations 140, 145 are land based stations and the radio frequency broadcast audio signals are analog signals each modulated in an AM or FM mode. In some embodiments of the invention a receiver device is capable of receiving hybrid radio frequency broadcast audio signals, such as hybrid radio frequency broadcast audio signals from satellite transmissions for example. Such signals contain digital information modulated in an AM or FM mode. In FIG. 5C shown is a block diagram of another receiver device 502, in accordance with another embodiment of the invention. The receiver device 502 is similar to the receiver device 501 of FIG. 5B except that the tuners 561 are replaced with tuners 562. The tuners 562 are capable of demodulating hybrid radio frequency broadcast audio signals obtained by modulating digital signals, such as ibiquity HD (High Definition) digital signals or DAB (Digital Audio Broadcasting) signals for example. The tuners 562 demodulate hybrid radio frequency broadcast audio signals to produce digital signals. The digital signals are transmitted to the DSPs 590 by way of data paths 514 for conversion into streamed media audio formats. In the embodiment of FIG. 5C, each tuner 562 is capable of demodulating both radio frequency broadcast audio signals containing analog information and hybrid radio frequency broadcast audio signals containing digital audio information. More generally, each tuner 562 is capable of demodulating one or more of radio frequency broadcast audio signals containing analog audio information, radio frequency broadcast audio signals containing analog audio information and digital information, and hybrid radio frequency broadcast audio signals containing digital audio information.

Referring back to FIG. 1, as discussed above with reference to FIG. 1, user statistics on listeners are monitored for radio broadcasters. These statistics are collected by the network device 160. Further details of the functionality of the network device 160 will now be described with reference to FIG. 8. In FIG. 8 the network device 160 has a display unit 810, an interface 820, and a processing function 830. The interface 820 receives from a receiver device information on user statistics for at least one radio broadcaster. The user statistics include for example information on the number of users and listening times. It is to be clearly understood, however, that in other implementations the user statistics contain any suitable information that provides a radio broadcaster with useful statistical information. The processing function 830 is used to process the information to generate statistical information for use by the radio broadcaster(s). For example, in some implementations the processing function 830 performs averages in the number of users listening to the programming of a radio broadcaster for different time slots. The averages are taken over a predetermined period of time. The predetermined period of time over which the averages are taken include days, weeks, or months for example. In the example implementation the processing function 830 also processes information obtained from the averages for display at the display unit 810. In some implementations the receiver device that sends the user statistics to the network device 160 also performs at least some of the processing. For example, in some implementations the receiver device performs some averaging prior to sending the user statistics. In some of these implementations the processing function 830 only processes the received user statistics for display at the display unit 810. In some embodiments of the invention there is no display unit 810. In some of these embodiments the interface 820 transmits to radio broadcasters information received on the radio broadcasters. The information is transmitted at predetermined time intervals for example.

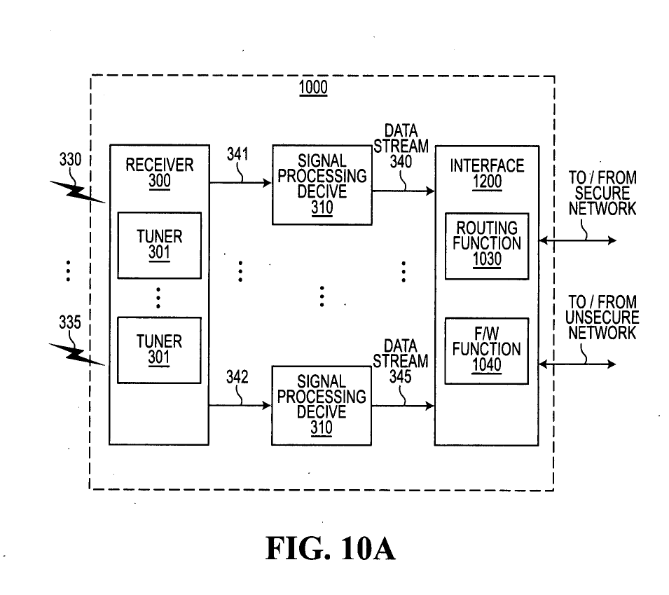

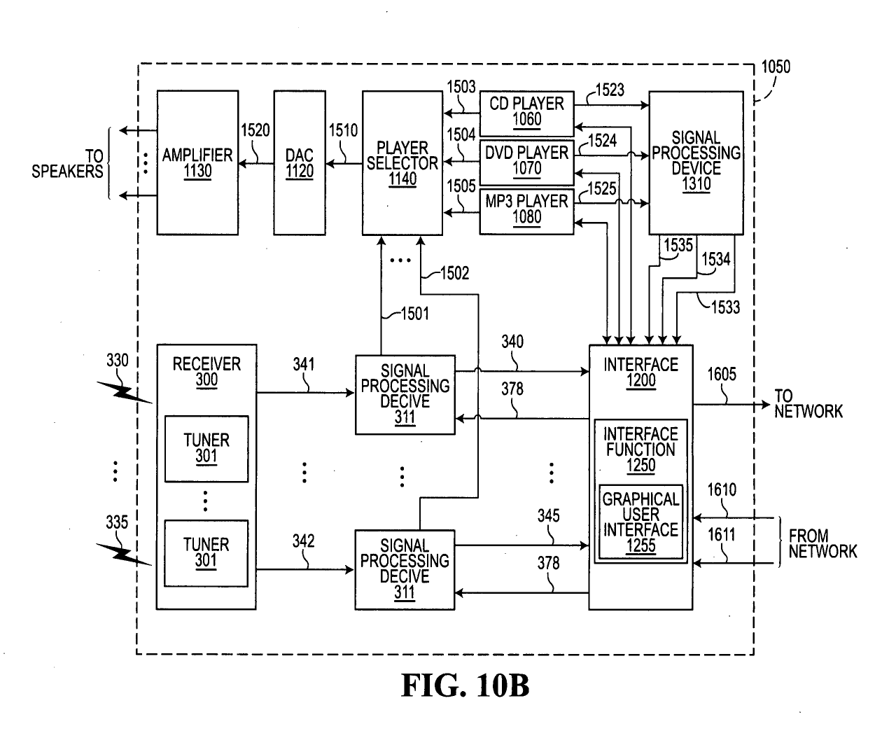

In some embodiments of the invention the functionality any of the receiver device 100 of FIGS. 1, 2A, 3A, the receiver device 260 of FIG. 2B, the receiver device 360 of FIG. 3B, and the receiver devices 500, 501, and 502 of respective FIGS. 5A, 5B, and 5C is implemented in apparatuses, such as routers, any suitable audio and/or video equipment capable outputting analog signals to a speaker system, and computing devices such as PCs and servers for example. Some of these devices will now be described with reference to FIGS. 10A and 10B.

Referring to FIG. 10A, shown is functional block diagram of a router 1000, in accordance with another embodiment of the invention. The router 1000 has functionality similar to that of the receiver device 100 of FIGS. 1, 2A, and 3A except that the interface 320 is replaced with an interface 1020 having a routing function 1030 and a F/W (FireWall) function 1040. The router 1000 is capable of providing the functionality of the receiver device 100 of FIG. 1. In addition, the routing function 1030 provides routing functionality for incoming data between a secure network and an insecure network. For example, responsive to receiving data in the form of a data packet for example, the routing function examines the data, performs an address translation, and transmits the data to a destination address. The F/W function 1040 performs filtering of the incoming data to provide a level of security. The filtering includes for example blocking incoming data originating from addresses from being transmitted onto the secure network.

In some embodiments of the invention, there is no F/W function 1040, and the routing function 1030 provide routing functionality between any two or more networks. Furthermore, the functionality of the router 1000 is described as having the functionality of the receiver device 100 of FIGS. 1, 2A, and 3A. However, it is to be clearly understood that embodiments of the invention are not limited to routers having the functionality of the receiver device 100. For example, in other embodiments of the invention a router has the functionality of any one of the receiver device 260 of FIG. 2B, the receiver device 360 of FIG. 3B, and the receiver devices 500, 501, and 502 of respective FIGS. 5A, 5B, and 5C.

Referring to FIG. 10B, shown is functional block diagram of a receiver device 1050, in accordance with another embodiment of the invention. The receiver device 1050 has receiver 300 with tuners 301. Signal processing devices 311 are coupled to the receiver 300 and an interface 1200 is coupled to the signal processing devices 311. The interface 1200 has an interface function 1250, and the interface function 1250 has a graphical user interface 1255. A CD (Compact Disc) player 1060, a DVD (Digital Video Player) 1070, and an MP3 player 1080 are coupled to the interface 1200 by way of a signal processing device 1310. The signal processing device 1310 is any suitable signal processing device, such as a DSP for example, capable of processing digital signals. The receiver device 1050 also has a player selector 1140, a DAC (Digital-to-Analog) converter 1120 and an amplifier 1130.

The receiver 300 receives radio frequency broadcast audio signals 330, 335, and the tuners 301 demodulate the radio frequency broadcast audio signals 330, 335 to produce the demodulated signals 341, 342. The signal processing devices 311 convert the demodulated signals 341, 342 into data streams 340, 345, each having a streamed media audio format. The interface 1200 receives the data streams 340, 345, and transmits the data streams 340, 345 to destination addresses. The signal processing devices 311 also perform digital sound processing functions such as de-emphasis, volume control, noise reduction, bass and treble control for example to produce digital signals 1501, 1502.

The graphical user interface 1255 transmits to one or more destination addresses information 1605 on radio broadcasters available for listening and on available media players, such as the CD player 1060, the DVD player 1070, and the MP3 player 1080. The information 1605 also contains graphical display information for user selection of the available media players and radio broadcasters. The CD player 1060 and the MP3 player 1080 provide the interface 1200 with information on music that is available for listening. The DVD player 1070 also provides the interface 1200 with information on one or more videos that are available for viewing. The graphical user interface transmits the information provided by the CD player 1060, the MP3 player 1080, and the DVD player 1070 as part of the information 1605 for user selection of particular music and videos.

Responsive to receiving a request 1610 for accessing a particular media player the interface function 1250 instructs one of the CD player 1060, the DVD player 1070, the MP3 player 1080 being requested to play. Responsive to receiving a request 1611 for accessing programming from a particular radio broadcaster, the interface function 1250 determines which of the data streams 340, 345 contains programming from the particular radio broadcaster requested, and transmits the data stream.

Responsive to receiving from the interface 1200 instructions requesting audio information the CD player 1060 provides a digital signal 1523 to the signal processing device 1310. The signal processing device 1310 performs digital sound and video processing functions such as de-emphasis, volume control, noise reduction, bass and treble control for example to produce a data stream 1533 having a streamed media audio format. The interface 1200 transmits the data stream 1533 to one or more destination addresses.

Responsive to receiving from the interface 1200 instructions requesting audio and video information the DVD player 1070 provides to the signal processing device 1310 a digital signal 1524 containing video and audio information. The signal processing device 1310 performs digital sound processing functions such as de-emphasis, volume control, noise reduction, bass and treble control for example to produce a data stream 1534 having a streamed media format. The interface 1200 transmits the data stream 1534 to one or more destination addresses.

Responsive to receiving from the interface 1200 instructions requesting audio information the MP3 player 1080 provides a digital signal 1525 to the signal processing device 1310. The signal processing device 1310 performs digital sound processing functions such as de-emphasis, volume control, noise reduction, bass and treble control for example to produce a data stream 1535 having a streamed media audio format. The interface 1200 transmits the data stream 1535 to one or more destination addresses.

The CD player 1060, the DVD player 1070, and the MP3 player 1080 also provide respective digital signals 1503, 1504, 1505 to the player selector 1140. The player selector 1140 selects one of the digital signals 1501, 1502, 1503, 1504, 1505 to be transmitted to the DAC 1120 by way of data path 1510. In some implementations the player selector 1140 is operable by a user. The DAC 1120 converts the digital signal 1520 received from the player selector 1140 into an analog signal 1520, and the amplifier amplifies the analog signal 1520.

In the embodiment of FIG. 10B, the CD player 1060, the DVD player 1070, and the MP3 player 1080 are internal devices of the receiver device 1050. In other embodiments of the invention, one or more of the CD player 1060, the DVD player 1070, and the MP3 player 1080 are external devices connected to the receiver device 1050. Furthermore, in some embodiments of the invention a receiver device has the receiver 300 and one or more of the CD player 1060, the DVD player 1070, and the MP3 player 1080. In some embodiments of the invention a receiver device is operable to receive signals from one or more external media players such as CD players, DVD players, and MP3 players for example. Furthermore, it is to be clearly understood that the invention is not limited to CD players, DVD players, and MP3 players, and that in some embodiments a receiver device has any suitable media player and/or is operable to receive signals from any suitable external media player.

In the embodiment of FIG. 10B the signal processing device 1310 processes the digital signals 1523, 1524, 1525 from the CD player 1060, the DVD player 1070, and the MP3 player 1080. In some implementations two or more signal processing devices are used to process the digital signals 1523, 1524, 1525. In yet other implementations the functionalities of the signal processing devices 311, 1310 are provided by one or more signal processing devices.

Numerous modifications and variations of the present invention are possible in light of the above teachings. It is therefore to be understood that within the scope of the appended claims, the invention may be practiced otherwise than as specifically described herein.

We claim:

1. A receiver device comprising:
a receiver comprising at least one tuner each adapted to demodulate a respective radio frequency broadcast audio signal to produce a demodulated signal, each radio frequency broadcast audio signal comprising one of an AM (Amplitude Modulation) radio frequency broadcast audio signal and an FM (Frequency Modulation) radio frequency broadcast audio signal;
at least one signal processing device for converting each demodulated signal into a respective data stream having a streamed media audio format; and
an interface for transmitting each data stream to a respective destination address.

2. A receiver device according to claim 1 wherein the interface comprises an interface function for receiving instructions to transmit a particular data stream to the respective destination address of the particular data stream.

3. A receiver device according to claim 2 wherein the interface function comprises a graphical user interface for providing to each destination address information on radio broadcasters that are available for listening.

4. A receiver device according to claim 3 wherein the graphical user interface is adapted to provide to each destination address information for selection of available streamed media audio formats.

5. A receiver device according to claim 3 wherein the graphical user interface is a graphical user web interface.

6. A receiver device according to claim 1 wherein the interface comprises an interface function for tuning the frequency of reception of each tuner.

7. A receiver device according to claim 6 wherein the interface function comprises a graphical user interface adapted to provide display information for selecting at a remote network device the frequency of reception of any of the at least one tuner.

8. A receiver device according to claim 7 wherein the graphical user interface is a graphical user web interface.

9. A receiver device according to claim 1 wherein the at least one tuner comprises a plurality of tuners.

10. A receiver device according to claim 9 wherein the at least one signal processing device comprises a plurality of signal processing devices.

11. A receiver device according to claim 9 wherein the interface comprises an interface function adapted to:
responsive to receiving a request for programming of a particular radio broadcaster to be transmitted to a particular destination address, determine which data stream contains information on the programming of the particular radio broadcaster and transmit the data stream containing the information on the programming of the particular radio broadcaster to the particular destination address.

12. A receiver device according to claim 9 wherein each signal processing device comprises a DSP (Digital Signal Processor) for performing a media format conversion.

13. A receiver device according to claim 12 wherein each signal processing device comprises an ADC (Analog-to-Digital Converter).

14. A receiver device according to claim 1 comprising a monitoring function adapted to monitor user statistics for at least one radio broadcaster.

15. A receiver device according to claim 14 wherein the monitoring function is adapted to transmit the user statistics to a predetermined address.

16. A receiver device according to claim 14 wherein for each radio broadcaster the user statistics comprise information on the number of users and listening times.

17. A receiver device according to claim 1 comprising an interface function for receiving from a remote network device a request for a particular type of streamed media audio format, the interface function being adapted to instruct any of the at least one signal processing device to perform a media conversion into the particular type of streamed media audio format.

18. A receiver device according to claim 1 comprising an interface function for receiving from a remote network device a request for a particular type of streamed media audio format, the interface function being adapted to perform on the respective data stream of any of the at least one signal processing device a media conversion into the particular type of streamed media audio format.

19. A receiver device according to claim 1 wherein the at least one tuner comprises one tuner.

20. A receiver device according to claim 1 wherein a tuner of the at least one tuner is adapted to perform demodulation for only one frequency of reception.

21. A receiver device according to claim 1 wherein the radio frequency broadcast audio signal is a hybrid radio frequency broadcast audio signal containing digital information.

22. A PC (Personal Computer) comprising the receiver device of claim 1.

23. A computing device comprising the receiver device of claim 1.

24. A receiver device according to claim 1 comprising:
a DAC (Digital-to-Analog Converter) adapted to convert the respective data stream from a particular signal processing device into an analog signal, and;
an amplifier for amplifying the analog signal.

25. A receiver device according to claim 1 comprising means for performing digital processing functions on at least one digital signal from at least one media player other than the receiver to produce at least one respective data stream each having a streamed media format, and wherein the interface comprises an interface function for transmitting the at least one respective data stream to at least one destination address.

26. A receiver device according to claim 25 comprising the at least one media player.

27. A router comprising the apparatus of claim 1, the router comprising a routing function for routing incoming data.

28. A router according to claim 27 comprising a firewall function for filtering the incoming data.

29. A network device comprising:
an interface adapted to receive from a receiver device information on user statistics for at least one radio broadcaster, and
a processing function adapted to process the information to generate statistical information for use by the at least one radio broadcaster.

30. A network device according to claim 29 wherein for each radio broadcaster the user statistics comprise information on the number of users and listening times.

31. A system comprising:
at least one network device coupled to a network; and
a receiver device comprising:
a receiver comprising at least one tuner each adapted to demodulate a respective radio frequency broadcast audio signal to produce a demodulated signal, each radio frequency broadcast audio signal comprising one of an AM (Amplitude Modulation) radio frequency broadcast audio signal and an FM (Frequency Modulation) radio frequency broadcast audio signal;
at least one signal processing device for converting each demodulated signal into a respective data stream having a streamed media audio format; and
an interface for transmitting the respective data stream of each signal processing device to the at least one network device.

32. A system according to claim 31 wherein the receiver device comprises a monitoring function adapted to monitor respective user statistics for at least one radio broadcaster, the system comprising another network device comprising:
an interface adapted to receive from the receiver device information on the user statistics, and
a processing function adapted to process the information to generate statistical information for use by the at least one radio broadcaster.

33. A method comprising:
demodulating a radio frequency broadcast audio signal to produce a demodulated signal, the radio frequency broadcast audio signal comprising one of an AM (Amplitude Modulation) radio frequency broadcast audio signal and an FM (Frequency Modulation) radio frequency broadcast audio signal;
converting the demodulated signal into a data stream having a streamed media audio format; and
transmitting the data stream to a destination address.

34. A method according to claim 33 comprising receiving instructions to transmit the data stream to a destination address.

35. A method according to claim 33 comprising:
receiving instructions for tuning a receiver from a remote network device, and;
tuning the receiver.

36. A method according to claim 33 comprising:
receiving a request for a particular streamed media audio format from a remote network device, and;
performing a media conversion into the particular streamed media audio format to produce the data stream.

37. A method for a program to interact with a user comprising:
transmitting information for displaying at least one element each representing a respective radio broadcaster that is available for listening;
receiving a selection of one of the at least one element, and;
transmitting a data stream obtained from a received radio frequency broadcast audio signal, the data stream having a streamed media audio format.
